(19) United States
(12) Patent Application Publication
(10) Pub. No.: US 2026/0109335 A1
(43) Pub. Date: Apr. 23, 2026

(54) ELECTRO-MECHANICAL BRAKE AND CONTROL METHOD THEREFOR

(71) Applicant: HYUNDAI MOBIS CO., LTD., Seoul (KR)

(72) Inventor: Dong Hwan LIM, Yongin-si (KR)

(73) Assignee: HYUNDAI MOBIS CO., LTD., Seoul (KR)

(21) Appl. No.: 19/258,207

(22) Filed: Jul. 2, 2025

(30) Foreign Application Priority Data
Jul. 5, 2024 (KR) 10-2024-0088635

(51) Int. Cl. B60T 17/22; B60T 13/74

(52) U.S. Cl. CPC B60T 17/221; B60T 13/746

(57) ABSTRACT

According to an embodiment of the present disclosure, disclosed is a control method of electro-mechanical brake including a piston configured to move forward toward a wheel disc or backward to the opposite side of the wheel disc, the method including perform a maximum backward position setting of setting a reference position as a maximum backward position when the position at which the piston may move backward at the maximum is referred to as the maximum backward position; perform a position controlling of continuously controlling the position of the piston by moving the piston forward or backward based on the reference position; perform a braking force determining of determining whether a braking force is generated when the piston is located at the reference position during the position controlling; in response to a determination that the braking force is generated, perform a maximum backward position resetting of resetting the maximum backward position as a position other than the reference position; and controlling the position of the piston based on the reset maximum backward position.

### CROSS-REFERENCE TO RELATED APPLICATIONS

The present application claims priority to Patent Application No. 10-2024-0088635, filed on Jul. 5, 2024 in Korea, the entire contents of which are incorporated herein by reference.

### TECHNICAL FIELD

The present disclosure relates to an electro-mechanical brake and a control method thereof.

### BACKGROUND ART

The content described in this section merely provides background information for the present disclosure, but does not constitute the related art.

An electro-mechanical brake (EMB) is a brake apparatus that generates a friction braking force. In the electro-mechanical brake, an actuator driven by a motor is mounted on a brake caliper. The electro-mechanical brake presses the wheel disc using motor, gear box, screw, piston, brake pad, or the like without a medium called brake fluid.

The electro-mechanical brake has a mechanism similar to that of an electronic parking brake (EPB), but since the electro-mechanical brake is a main brake apparatus used during driving, higher reliability, higher durability, and the like are required.

When the driver depresses the pedal, the electro-mechanical brake calculates the required braking force and applies a brake command to each wheel. When the brake command is applied, the motor starts to rotate to advance the piston, which presses the brake pad. The brake pads press the wheel discs so that the braking force is generated.

When the electro-mechanical brake performs vehicle posture control such as anti-lock braking system (ABS) control and vehicle dynamic control (VDC), high braking responsiveness is required. This is because the braking responsiveness is directly related to the braking stability.

A smaller air gap, which is the separation distance between the piston and the brake pad, is advantageous for a higher reaction speed to the generation of the braking force and a higher braking responsiveness. However, when the control for keeping the air gap between the piston and the brake pad small is performed, there is a high possibility that a wheel lock occurs or a drag phenomenon occurs. For example, in a case where the brake pad is thermally expanded by performing frequent braking, there arises a problem that the possibility of occurrence of a wheel lock or a drag phenomenon is increased when the control of keeping the air gap small is performed. There is a need for an apparatus or a control method that may solve such a problem.

### DISCLOSURE OF INVENTION

### Technical Problem

Accordingly, the present disclosure has been made to solve these problems, and a main object thereof is to provide an electro-mechanical brake and a control method for the electro-mechanical brake that perform control to keep an air gap small and provide high braking responsiveness.

In addition, a main object of the present disclosure is to provide an electro-mechanical brake and a control method of the electro-mechanical brake in which a wheel lock or a drag phenomenon due to thermal expansion of a brake pad does not occur while performing control to keep an air gap small.

The problems to be solved by the present invention are not limited to the above-mentioned problems, and other problems that are not mentioned will be clearly understood by those skilled in the art from the following description.

### Solution to Problem

According to an aspect of the present disclosure for achieving the above object, provided is a control method of electro-mechanical brake including a piston configured to move forward toward a wheel disc or backward to the opposite side of the wheel disc, the method including perform a maximum backward position setting of setting a reference position as a maximum backward position when the position at which the piston may move backward at the maximum is referred to as the maximum backward position; perform a position control of continuously controlling the position of the piston by moving the piston forward or backward based on the reference position; perform a braking force determination of determining whether a braking force is generated when the piston is located at the reference position during the position controlling; in response to a determination that the braking force is generated, perform a maximum backward position resetting of resetting the maximum backward position as a position other than the reference position; and perform a position control of controlling the position of the piston based on the reset maximum backward position.

According to an aspect of the present disclosure for achieving the above object, provided is an electro-mechanical brake including a piston configured to move forward toward a wheel disc or backward to the opposite side of the wheel disc, including at least one or more processors configured to: perform a maximum backward position setting of setting a reference position as a maximum backward position when the position at which the piston may move backward at the maximum is referred to as the maximum backward position; perform a position control of continuously controlling the position of the piston by moving the piston forward or backward based on the reference position; perform a braking force determining of determining whether a braking force is generated when the piston is located at the reference position during the position controlling; in response to a determination that the braking force is generated, perform a maximum backward position resetting of resetting the maximum backward position as a position other than the reference position; and perform a position control of controlling the position of the piston based on the reset maximum backward position.

### Effects of Invention

As described above, according to the present embodiment, the electro-mechanical brake may perform the setting and resetting of the maximum backward position of the piston to keep the air gap between the piston and the brake pad as small as possible during the position control of the piston.

There is an effect that the air gap may be kept as small as possible to provide high braking responsiveness.

In addition, the present disclosure has an effect that a wheel lock or drag phenomenon due to thermal expansion of the brake pad does not occur while performing control to keep the air gap small.

### BRIEF DESCRIPTION OF DRAWINGS

FIG. 1 is a functional block diagram of the electro-mechanical brake according to an embodiment of the present disclosure.

FIG. 2 is a diagram illustrating the Braking force generating unit according to an embodiment of the present disclosure.

FIGS. 3A and 3B are diagrams illustrating the electro-mechanical brake in which the thermal expansion phenomenon does not occur according to an embodiment of the present disclosure.

FIGS. 4A and 4B are diagrams illustrating the electro-mechanical brake in which the thermal expansion phenomenon occurs according to an embodiment of the present disclosure.

FIGS. 5 and 6 are diagrams illustrating the architecture of the electro-mechanical brake according to various embodiments of the present disclosure.

FIG. 7 is a flowchart illustrating a control method of the electro-mechanical brake according to an embodiment of the present disclosure.

FIG. 8 is a flowchart illustrating a detailed process of step S730 of FIG. 7.

FIG. 9 is a diagram illustrating a force map according to the maximum backward position according to an embodiment of the present disclosure.

### DETAILED DISCLOSURE FOR CARRYING OUT INVENTION

Hereinafter, some embodiments of the present disclosure will be described in detail with reference to exemplary drawings. Note that when components in each drawing are denoted by reference numerals, the same components are denoted by the same numerals as much as possible even if they are denoted on different drawings. In addition, in describing the present disclosure, if it is determined that a specific description of a related known configuration or function may obscure the gist of the present disclosure, the detailed description thereof will be omitted.

In describing the components of the present invention, the terms “first”, “second”, “A”, “B”, “(a)”, “(b)”, and the like may be used. These terms are only used to distinguish the components from other components, and the nature, sequence, order, or the like of the components is not limited by these terms.

When any component is described as being “connected,” “coupled,” or “linked” to another component, it should be understood that the component may be directly connected or linked to the other element, but another component may also be “connected,” “coupled,” or “linked” between each component.

Throughout the specification, when it is stated that a certain portion “includes” or “comprises” a specific component, it shall be understood that, unless explicitly otherwise specified, this does not exclude other components but may further include additional components.

The terms “unit”, “module” and the like described in the specification mean a unit that processes at least one function or operation, and may be implemented by hardware or software, or a combination of hardware and software.

Unless otherwise specified, it should be understood that the description of one embodiment may be applied to other embodiments.

The description set forth below in connection with the appended drawings is intended to describe exemplary embodiments of the invention and is not intended to represent the only embodiments in which the invention may be practiced.

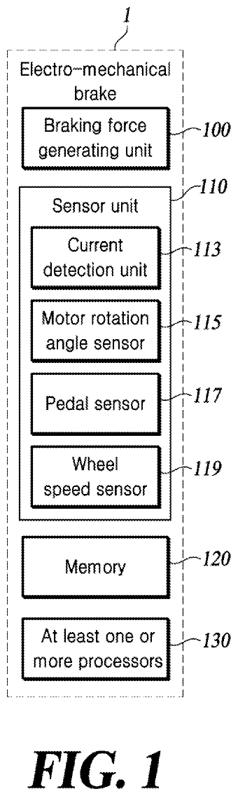

FIG. 1 is a functional block diagram of the electro-mechanical brake according to an embodiment of the present disclosure.

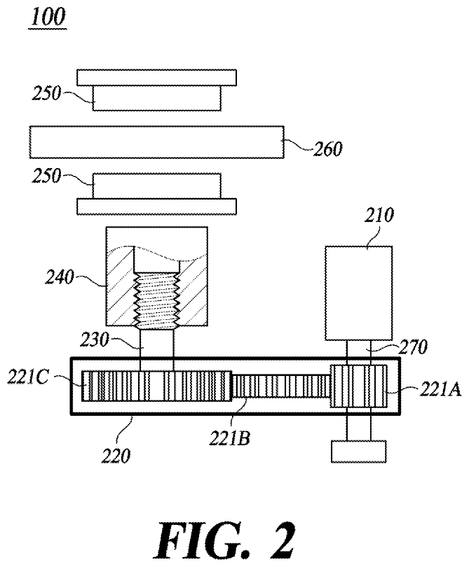

FIG. 2 is a diagram illustrating the Braking force generating unit according to an embodiment of the present disclosure.

Referring to FIGS. 1 and 2, the electro-mechanical brake (EMB) 1 includes all or a part of the Braking force generating unit 100, the sensor unit 110, the memory 120, and at least one or more processors 130.

The electro-mechanical brake 1 generates a friction braking force. The electro-mechanical brake 1 does not use hydraulic pressure, resulting in a faster response speed and being more environmentally friendly compared to a hydraulic brake (not shown). The electro-mechanical brake 1 is capable of independently controlling each wheel (not shown), thereby enhancing braking stability.

When the driver depresses a brake pedal (not shown), the Braking force generating unit 100 calculates a necessary braking force based on a stroke amount of the driver, and then generates the braking force. The Braking force generating unit 100 may be mounted on the wheel of the vehicle to generate the braking force. The Braking force generating unit 100 may be mounted on each wheel of the vehicle. The Braking force generating unit 100 may independently generate and independently control the braking force for each wheel. The Braking force generating unit 100 brakes the vehicle by changing the kinetic energy of the vehicle in the form of thermal energy using the frictional force.

The Braking force generating unit 100 may include all or a part of motor 210, gear box 220, power transfer unit 230, piston 240, brake pad 250, rotation shaft 270, and wheel disc 260. The Braking force generating unit 100 is not limited by the disclosure of the drawings. For example, the number, shape, size, arrangement, and the like of the motor 210, the gear box 220, the power transfer unit 230, the piston 240, the brake pad 250, the rotation shaft 270, and the wheel disc 260 are not limited by the disclosure of the drawings.

The motor 210 rotates to move the piston 240. As used herein, the direction of the piston is defined. The forward movement means the case where the piston 240 moves toward the wheel disc 260 side or the case where the pistons 240 move toward the brake pad 250 side. The backward movement means the case where the piston 240 moves in the opposite direction to the wheel disc 260 side or the case where the pistons 240 move in the opposite direction of the brake pad 250 side.

According to an embodiment, the motor 210 may be DC motor, AC motor, induction motor, synchronous motor, step motor, servo motor, Brushless Direct Current (BLDC) motor, linear motor, Permanent Magnet Synchronous Motor (PMSM), or the like.

One side of the gear box 220 is connected to the motor 210, and the other side of the gear box 220 is connected to the power transfer unit 230. The gearbox 220 is configured to transfer power of the motor 210 to the power transfer unit 230. The gear box 220 includes a plurality of gears 221 therein. The gear box 220 may boost the rotational force by meshing and rotating the plurality of gears 221. The shape and arrangement of the gear box 220 are not limited by the drawings. Each of the plurality of gears 221 is not limited to the shape and number disclosed in the drawings.

The power transfer unit 230 may receive power from the gear box 220. The power transfer unit 230 may provide power to the piston 240.

According to an embodiment, the power transfer unit 230 may be a screw shaft. In this case, the piston 240 may be screw coupled to the screw shaft. In this case, when the screw shaft rotates, the screw connection is connected or disconnected, and the piston 240 moves forward or backward.

The piston 240 receives power from the power transfer unit 230 and moves. When piston 240 moves forward, piston 240 presses on brake pad 250. The brake pad 250 presses the rotating wheel disc 260 to brake the vehicle.

The brake pads 250 may be a pair. A pair of brake pads 250 may be disposed on either side of the wheel disc 260. The wheel disc 260 is coupled to and rotates with the wheels of the vehicle. When the piston 240 presses the brake pad 250, the brake pad 250 may press the wheel disc 260. When the brake pad 250 presses the wheel disc 260, the brake pad 250 is compressed and a braking force is generated. As the distance that the piston 240 moves forward increases, the braking force increases because the force with which the brake pad presses the wheel disc 260 increases.

The sensor unit 110 may include current detection unit 113, motor rotation angle sensor 115, pedal sensor 117, wheel speed sensor 119, and the like.

According to an embodiment, the current detection unit 113 may detect a current flowing through the motor 210. For example, a current sensor (not shown) may be included to detect a current flowing through the motor 210. The electro-mechanical brake 1 may control a current flowing through the motor 210 by using the current detection unit 113.

According to an embodiment, the motor rotation angle sensor 115 may detect a rotation angle of the motor 210. The rotation of the motor 210 causes the piston 240 to move forward or backward. That is, since the position of the piston 240 is determined by the rotation angle of the motor 210, the electro-mechanical brake 1 may detect the position of the pistons 240 using the motor rotation angle sensor.

According to an embodiment, the pedal sensor 117 generates the brake pedal signal according to the stroke amount of the brake pedal. The electro-mechanical brake 1 may calculate a braking force to be generated based on a signal from the pedal sensor 117.

According to an embodiment, the wheel speed sensor 119 measures the wheel speed of the wheel of the vehicle. The wheel speed sensor 119 may transmit the measured wheel speed to at least one or more processors 130.

A force map may be stored in the memory 120. The map in which braking force values corresponding to the position of the piston 240 are indexed is referred to as the force map. A force sensor-less system refers to the system that estimates the braking force without using the force sensor. The electro-mechanical brake 1 according to the present disclosure may determine the braking force and adjust the braking force by the force map even without a force sensor. This is because the position of the piston 240 is known by the motor rotation angle sensor 115, and the braking force corresponding to the position of the pistons 240 is known by the force map.

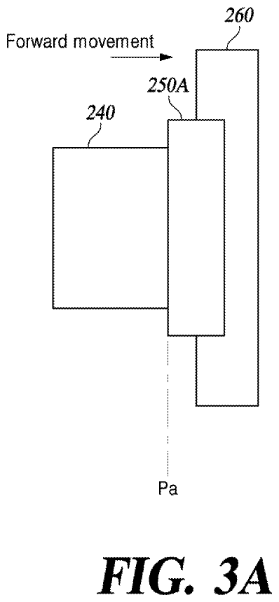

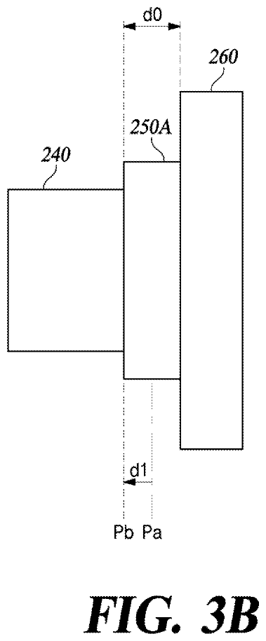

FIGS. 3A and 3B are diagrams illustrating the electro-mechanical brake in which the thermal expansion phenomenon does not occur according to an embodiment of the present disclosure.

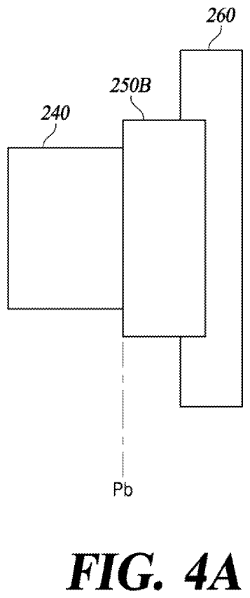

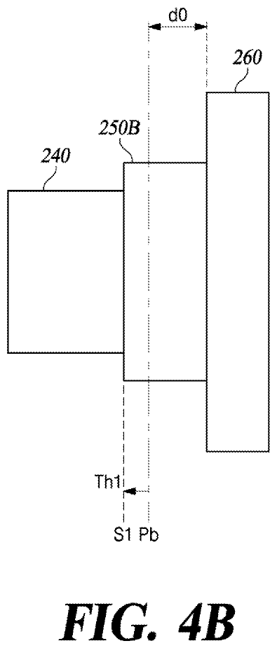

Referring to FIGS. 3A and 3B, the brake pad 250A that is not thermally expanded is shown. The thermally expanded brake pad 250B is described below in FIGS. 4A and 4B. In the present specification, the position of the piston 240 means the position of the front surface portion of the piston 240. Pa disclosed in FIGS. 3A and 3B shows the same position.

FIG. 3A illustrates a state in which the piston 240 moves forward, resulting in the generation of braking force. FIG. 3B illustrates a state in which the piston 240 moves backward by d1, resulting in no braking force being generated.

When the piston 240 moves forward and is positioned at Pa, the piston 240 presses the brake pad 250A, and the wheel disc 260 is pressed by the brake pad 250A, so that the braking force is generated.

Referring to FIG. 3B, a reference position Pb of the piston 240 is illustrated. A state before traveling of the vehicle is started is defined as a vehicle initial state. Since the vehicle initial state is the state before traveling is performed, it is a state in which braking is not performed and a state in which thermal expansion of the brake pad 250A due to braking does not occur.

The reference position Pb is defined when the vehicle is in the vehicle initial state. Specifically, the reference position Pb refers to the position of the piston 240 just before the piston 240, which is apart from the brake pads 250, 250A in the vehicle initial state, moves forward to the brake pads 250, 250A side and the braking force is started to be generated by the forward movement of the piston 240, or the position of the pistons 240 when the braking force starts to be generated by forward movement of the piston 240. That is, in the vehicle initial state, when the piston 240 is at the reference position Pb, no braking force is generated. Referring to FIGS. 3B and 4B, a position spaced apart from the wheel disc 260 by d0 is the reference position Pb. When the brake pad 250B (FIG. 4A) is thermally expanded, the braking force may be generated even when the piston 240 is positioned at the reference position Pb, which will be described later.

Referring to FIGS. 3A and 3B in parallel, when the piston 240 located at Pa moves backward by the distance d1, the piston 240 is located at the reference position Pb. When the piston 240 is located at the reference position Pb, the wheel disc 260 is not pressed by the piston 240 and the brake pad 250A, and thus no braking force is generated.

The electro-mechanical brake 1 may set the maximum backward position. Here, the maximum backward position refers to the position at which the piston 240 may move backward to the maximum.

When the electro-mechanical brake 1 performs anti-lock braking system (ABS) control, vehicle dynamic control (VDC), vehicle posture control, and the like, high braking responsiveness is required. This is because the braking responsiveness is directly related to the braking stability.

FIGS. 3A and 3B illustrate the brake pad 250A that is not thermally expanded, and when the brake pad 250A is not thermally expandable, the electro-mechanical brake 1 may set the reference position Pb as the maximum backward position of the piston 240. This is because the braking force is not generated when the piston 240 is located at the reference position Pb, and setting the reference position Pb as the maximum backward position reduces the distance between the piston 240 and the brake pad 250A, thereby improving braking responsiveness.

When the position further backward than the reference position Pb is set as the maximum backward position, the piston 240 at the maximum backward position needs to move a relatively longer distance to generate a braking force, and thus the braking responsiveness may be lower than that in the case where the reference position Pb is set as the maximum backward position. Therefore, it is preferable to set the reference position Pb as the maximum backward position for high braking responsiveness.

That is, when the brake pad 250A is not in the expanded state, in a situation in which high braking responsiveness is required, such as anti-lock braking system (ABS) control, vehicle dynamic control (VDC), and vehicle posture control, the electro-mechanical brake 1 may set the reference position Pb as the maximum backward position during position control of the piston 240.

FIGS. 4A and 4B are diagrams illustrating the electro-mechanical brake in which the thermal expansion phenomenon occurs according to an embodiment of the present disclosure.

Referring to FIGS. 4A and 4B, Pb disclosed in FIGS. 4A and 4B shows the same position as Pb in FIGS. 3A and 3B.

As FIGS. 4A and 4B show the thermally expanded brake pad 250B, the brake pad 250B of FIGS. 4A and 4B is bulkier than the brake pad 250A of FIGS. 3A and 3B.

Referring to FIG. 4A, when the brake pad 250B is thermally expanded and the position of the piston 240 is the reference position Pb, the wheel disc 260 is pressed to generate the braking force. As described above, FIG. 3B, in which the braking force is not generated at the reference position Pb, and FIG. 4A, in which the braking force is generated, are compared with each other.

That is, in a case where the maximum backward position of the piston 240 is set as the reference position Pb and the brake pad 250B is thermally expanded (FIG. 4A), the braking force is generated even when the piston 240 moves backward to the reference position Pb which is the maximum backward positions. That is, when the maximum backward position of the piston 240 is the reference position Pb and the brake pad 250B is thermally expanded, the wheel lock or drag phenomenon may occur when performing vehicle posture control such as anti-lock braking system (ABS) control and vehicle dynamic control (VDC).

Therefore, when the brake pad 250B is thermally expanded, in order to prevent the wheel lock or drag phenomenon, the electro-mechanical brake 1 according to the present disclosure may reset the maximum backward position of the piston 240 as the position further backward than the reference position Pb.

Referring to FIG. 4B, when the piston 240 is located at the first position S1, which is a position when the piston 240 is further moved backward by the first threshold Th1 from the reference position Pb, the wheel disc 260 is not pressed, and thus no braking force is generated.

That is, when the brake pad 250B is thermally expanded, the first position S1 of the piston 240 may be reset as the maximum backward position. In this case, no braking force is generated when the piston 240 is located at the maximum backward position, and thus no wheel lock and drag phenomenon occurs. In addition, since the braking responsiveness is high, the braking force may be quickly generated when the braking force is required.

When the brake pad 250 is in a more expanded state than that disclosed in FIGS. 4A and 4B, the electro-mechanical brake 1 may reset the second position (not shown) or the third position (not shown), as the maximum backward position. The second position refers to the position of the piston 240 when it is further moved backward than the first position S1, and the third position refers to the position of the piston 240 when it is further moved backward than the second position.

At least one or more processors 130 may perform the maximum backward position setting of setting the reference position Pb as the maximum backward position. At least one or more processors 130 may perform the position controlling of continuously controlling the position of the piston 240 by moving forward or backward the piston 240 based on the reference position Pb. At least one or more processors 130 may perform the braking force determining of determining whether a braking force is generated when the piston 240 is located at the reference position Pb while performing the position controlling. When it is determined that the braking force is generated in the braking force determining, at least one or more processors 130 may perform the maximum backward position resetting of resetting the maximum backward position as the position other than the reference position Pb.

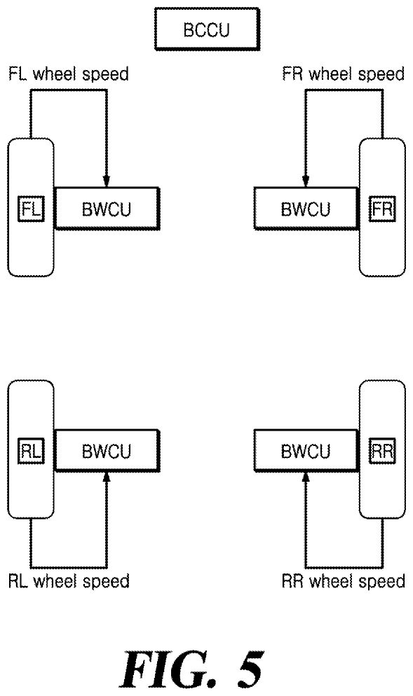

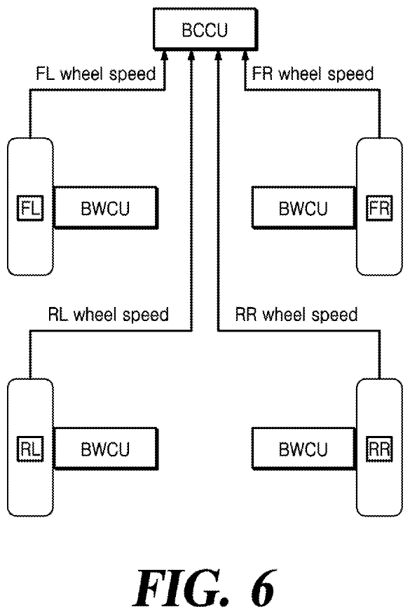

FIGS. 5 and 6 are diagrams illustrating the architecture of the electro-mechanical brake according to various embodiments of the present disclosure.

Referring to FIGS. 5 and 6 in parallel, the main controller (BCCU, Brake Center Control Unit) and the controller (BWCU, brake wheel control unit) are disclosed. At least one or more processors 130 may be mounted on the main controller BCCU and the controller BWCU. In FIGS. 5 and 6, front left wheel FL, front right wheel FR, rear left wheel RL, and rear right wheel RR are disclosed.

In the case of the architecture disclosed in FIG. 5, the controller BWCU directly receives the signal of the wheel speed sensor 119.

In the case of the architecture disclosed in FIG. 6, the controller BWCU does not receive the signal of the wheel speed sensor 119, and the main controller BCCU receives the signal of the wheel speed sensor 119.

The architectures disclosed in FIGS. 5 and 6 are merely exemplary, and the architecture of the electro-mechanical brake 1 according to the present disclosure is not limited by the disclosure in FIGS. 5 and 6.

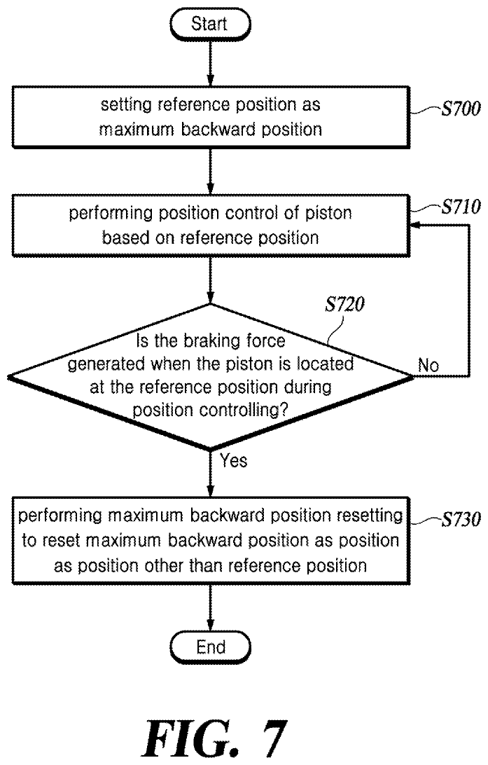

FIG. 7 is a flowchart illustrating a control method of the electro-mechanical brake according to an embodiment of the present disclosure.

Referring to FIG. 7, the electro-mechanical brake 1 may set the reference position Pb as the maximum backward position (S700, maximum backward position setting). The reference position (Pb) and the maximum backward position are defined above. When ABS control, VDC, vehicle posture control, and the like are performed in a state in which the brake pad 250A is not expanded, the electro-mechanical brake 1 may set the reference position Pb as the maximum backward position. This is because the braking responsiveness may be improved when the reference position Pb is set as the maximum backward position.

The electro-mechanical brake 1 may perform the position control of the piston 240 based on the reference position Pb (S710, position controlling). Specifically, when the vehicle posture control such as the ABS control or the VDC is performed, the position control of the piston 240 may be performed. Since the piston 240 may repeat the forward movement or the backward movement while the step S710 is performed, the position of the piston 240 may be continuously changed while the step S710 is performed. However, according to the step S700, the piston 240 may move backward only to the reference position Pb, which is the maximum backward position, while the step S710 is performed.

The electro-mechanical brake 1 may determine whether a braking force is generated when the piston 240 is located at the reference position Pb during position control according to step S710 (S720, braking force determining).

The step S720 will be described in more detail.

According to an embodiment, when the vehicle speed reduction phenomenon occurs, the electro-mechanical brake 1 may determine that the braking force is generated. The vehicle speed reduction phenomenon means a phenomenon in which the calculated vehicle speed calculated based on the signal of the wheel speed sensor 119 is smaller than the reference vehicle speed. The reference vehicle speed means a vehicle speed when thermal expansion of the brake pad 250 has not occurred. The calculated vehicle speed when the thermal expansion occurs is smaller than a reference vehicle speed that is the vehicle speed when no thermal expansion occurs. This is because the braking force is generated even when the position of the piston 240 is the reference position Pb in a case where thermal expansion occurs, and thus the wheel speed is relatively lowered compared to a case where the braking force does not occur. For example, when the calculated vehicle speed is 85% or less of the reference vehicle speed, the electro-mechanical brake 1 may determine that the braking force has been generated. On the other hand, when the calculated vehicle speed is equal to the reference vehicle speed, that is, when the vehicle speed reduction phenomenon does not occur, the electro-mechanical brake 1 determines that the braking force does not occur.

According to an embodiment, when the non-braking force control signal is generated for more than the threshold time while performing the position control according to step S710, the electro-mechanical brake 1 may determine that the braking force is generated due to the expansion of the brake pad or the like. The non-braking force control signal means a signal for moving the piston 240 backward until no braking force is generated in the position controlling in step S710. For example, when the non-braking force control signal is generated for more than 400 ms, which is the threshold time, the electro-mechanical brake 1 may determine that the braking force is generated by the expansion of the brake pad 250. The threshold time means a time required until the piston 240 located at the position moved forward as much as possible moves backward and reaches a position where no braking force is generated. That is, when the non-braking force control signal is generated with respect to the piston 240 at any position, the piston 240 reaches a position where the braking force is not generated before the threshold time elapses. However, when the brake pad 250B is in an expanded state as in FIG. 4A, the braking force may be greater than 0 even when a threshold time has elapsed. This is because, in the case where the brake pad 250B is in the expanded state, the braking force becomes zero only when the vehicle travels a further distance backward as illustrated in FIG. 4B.

When it is determined that the braking force is generated in the step S720, the electro-mechanical brake 1 may reset the maximum backward position as the position other than the reference position Pb (S730, maximum backward position resetting). The maximum backward position resetting according to the step S730 refers to the resetting the position when the piston 240 is further backward from the reference position Pb as the maximum backward position. Hereinafter, the step S730 will be described in more detail.

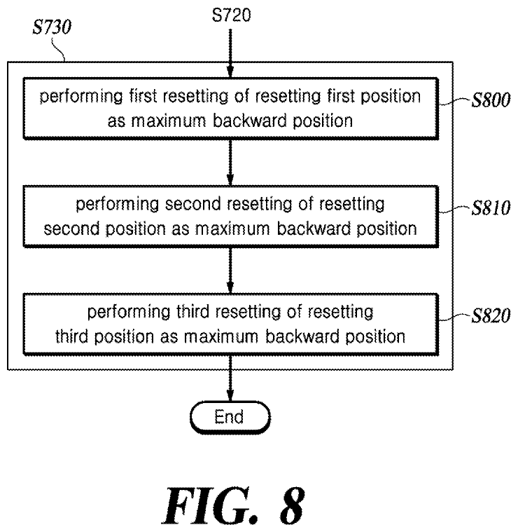

FIG. 8 is a flowchart illustrating a detailed process of step S730 of FIG. 7.

Referring to FIG. 8, the step S730 may include all or a part of the first resetting step S800 of resetting the first position S1, which is a position when the piston 240 is further moved backward by the first threshold from the reference position Pb, as the maximum backward position, the second resetting step S810 of resetting the second position (not shown) which is a position when the piston 240 is further moved backward from the reference position Pb by the second threshold, as the maximum backward position, and the third resetting step S820 of resetting the third position (not shown), which is a position where the piston 240 is further moved backwards by the third threshold, as the maximum backward position. Here, when the magnitudes of the first threshold to the third threshold are compared, the third threshold is the largest, and the first threshold is the smallest.

Steps S800 to S820 are performed according to the degree of expansion of the brake pad 250. The step S810 is performed when the brake pad 250 is expanded more than in the step S800, and the step S820 is performed when the brake pad 250 is expanded more than in the step S810.

For example, when the vehicle speed reduction phenomenon occurs or when a non-braking force control signal is generated for more than a threshold time, the brake pad 250 is expanded, and thus the electro-mechanical brake 1 may reset the first position S1 as the maximum backward position (S800).

When the step S800 is performed, when the electro-mechanical brake 1 performs the position control of the piston 240, the piston 240 may move backward only to the first position S1. When the braking force is generated even though the piston 240 moves backward to the maximum first position S1 according to the step S800, the electro-mechanical brake 1 may reset the maximum backward position as the second position instead of the first position S1 (S810).

When the step S810 is performed, when the electro-mechanical brake 1 performs the position control of the piston 240, the piston 240 may move backward only to the second position. When the braking force is generated even though the piston 240 moves backward to the maximum second position according to the step S810, the electro-mechanical brake 1 may reset the maximum backward position as the third position instead of the second position (S820).

That is, the electro-mechanical brake 1 may reset the maximum backward position of the piston 240 according to the degree of expansion of the brake pad 250 (S800 to S820).

During the vehicle posture control, since the braking responsiveness increases as the distance between the piston 240 and the brake pad 250 decreases, the electro-mechanical brake 1 may sequentially perform steps S800 to S820. That is, the electro-mechanical brake 1 may perform step S810 when the wheel lock or drag phenomenon occurs even though step S800 is performed, and may perform step S820 when the wheel lock or drag phenomenon occurs even after step S810 is performed.

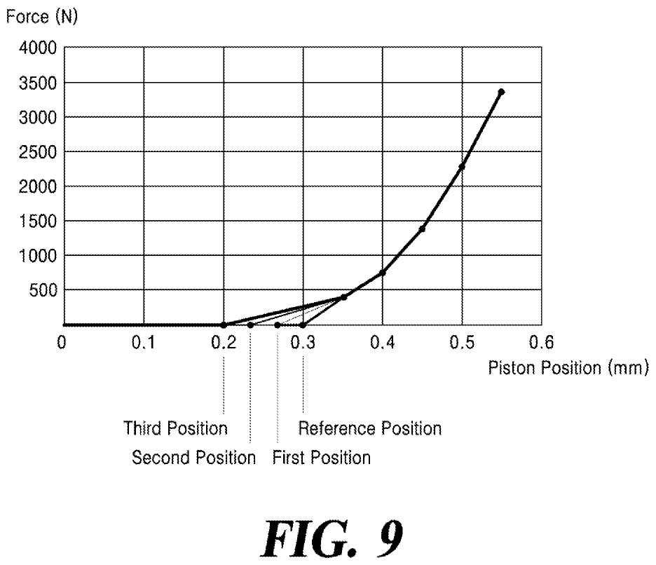

FIG. 9 is a diagram illustrating the force map according to the maximum backward position according to an embodiment of the present disclosure.

Referring to FIG. 9, the force map may be stored in the memory 120. A map in which braking force values corresponding to the position of the piston 240 are indexed is referred to as the force map. The force sensor-less system refers to the system that estimates the braking force without using the force sensor. According to the force map, the electro-mechanical brake 1 may determine the braking force and adjust the braking force even without the force sensor.

The four graphs disclosed in FIG. 9 respectively show the case where the maximum backward position is the reference position, the case where it is the first position S1, the case where it is the second position, and the case where it was the third position. The graph disclosed in FIG. 9 is merely an example for the force map, and the force map according to the present disclosure is not limited by FIG. 9. Referring to FIG. 9, the position at which the piston 240 is moved forward by 0.3 mm from a home position is the reference position Pb. The home position means the position at which the piston 240 is set to be positioned in a non-braking situation in which no braking force is required, such as a situation in which position control according to step S710 is not performed, ABS control is not performed, or vehicle posture control is not required. In a case where the piston 240 is disposed at the home position, since the air gap between the piston 240 and the brake pad 250 is large, when the position control of the piston 220 is performed so that high braking responsiveness is required, the piston 210 is controlled so as to move backward only to the maximum backward position instead of the home position. That is, in the electro-mechanical brake 1 according to the present disclosure, the reference position Pb, the first position S1, the second position, and the third position are set as the maximum backward position in consideration of whether or not the brake pad 250 is expanded and the degree of expansion. The electro-mechanical brake adjusts the maximum backward position to the maximum third position as the calculated vehicle speed becomes smaller than the reference vehicle speed or as the time for which the non-braking force control signal exceeds the threshold time becomes longer due to the vehicle speed reduction phenomenon.

As such, the electro-mechanical brake 1 according to the present disclosure has an advantage that, by adjusting the maximum backward position, it is possible to prevent the occurrence of the wheel lock and drag phenomenon during the position control of the piston 240, and it is also possible to improve the braking responsiveness.

For example, when the brake pad 250 is not expanded at all, the electro-mechanical brake 1 sets the reference position Pb as the maximum backward position. When it is determined that the braking force is generated during the position control of the piston 240 when the reference position Pb is the maximum backward position, the electro-mechanical brake 1 resets the first position S1 as the maximum backward position (S800). The first position in FIG. 9 is 0.267 mm, which is approximately 0.033 mm backward from the reference position of 0.3 mm.

When it is determined that the braking force is generated during the position control of the piston 240 when the first position S1 is the maximum backward position, the electro-mechanical brake 1 resets the second position as the maximum backward position (S810). The second position in FIG. 9 is 0.234 mm, approximately 0.066 mm backward from the reference position.

When it is determined that the braking force is generated during the position control of the piston 240 when the second position is the maximum backward position, the electro-mechanical brake 1 resets the third position as the maximum backward position (S820). The third position in FIG. 9 is 0.2 mm, approximately 0.01 mm backward from the reference position.

The first threshold value to the third threshold value may be appropriately set in consideration of the specifications of the electro-mechanical brake 1.

Each component of the apparatus or method according to the present disclosure may be implemented by hardware or software, or may be implemented by a combination of hardware and software. In addition, a function of each component may be implemented in software, and a microprocessor may be implemented to execute a function of the software corresponding to each component.

Various implementations of the systems and techniques described herein may be realized in digital electronic circuitry, integrated circuitry, field programmable gate arrays (FPGAs), application specific integrated circuits (ASICs), computer hardware, firmware, software, and/or combinations thereof. These various implementations may include implementation in one or more computer programs that are executable on a programmable system. The programmable system includes at least one programmable processor (which may be a special-purpose processor or a general-purpose processor) coupled to receive data and commands from, and to transmit data and commands to, storage systems, at least one input device, and at least one output device. Computer programs (also known as programs, software, software applications, or code) include commands for a programmable processor and are stored in a “computer readable recording medium”.

The computer-readable recording medium includes all kinds of recording devices in which data that may be read by a computer system is stored. The computer-readable recording medium may be a non-volatile or non-transitory medium such as ROM, CD-ROM, magnetic tape, floppy disc, memory card, hard disc, magneto-optical disc, or storage device, and may further include transitory medium such as data transmission medium. In addition, the computer-readable recording medium may be distributed in a network-connected computer system, and the computer-readable code may be stored and executed in a distributed manner.

In the flowcharts/timing diagrams of the present specification, each process is described as being executed sequentially, however, this is merely an example of the technical idea of an embodiment of the present disclosure. In other words, the flowcharts/timing diagrams are not limited to a chronological order, as those skilled in the art may make various modifications and variations to the sequence of the flowchart/timing diagram or to perform one or more of the processes in parallel without departing from the essential characteristics of the embodiments of the present disclosure.

The foregoing descriptions are merely illustrative of the technical idea of the present embodiment, and various modifications and variations may be made by those skilled in the art without departing from the essential characteristics of the present embodiment. Therefore, the present embodiments are not intended to limit the technical idea of the present embodiments, but are intended to be illustrative, and the scope of the technical idea of this embodiment is not limited by these embodiments. The protection scope of the present embodiment is to be construed according to the following claims, and all technical ideas within the scope equivalent thereto are construed as being included in the scope of rights of the present embodiment.

| | | |
|---|---|---|
| 1 | Description of Signs | |
| 2 | 1: Electro-mechanical brake | 100: Braking force generating |
| | | unit |
| 3 | 110: Sensor unit | 113: Current detection unit |
| 4 | 115: Motor rotation angle sensor | 117: Pedal sensor |
| 5 | 119: Wheel speed sensor | 120: Memory |
| 6 | 130: At least one or more | 210: Motor |
| | processors | |
| 7 | 220: Gear box | 221: A plurality of gears |
| 8 | 230: Power transfer unit | 240: Piston |
| 9 | 250: Brake pad | 260: Wheel disc |
| 10 | 270: Rotation shaft | |

What is claimed is:

1. A control method of electro-mechanical brake comprising a piston configured to move forward toward a wheel disc or backward to the opposite side of the wheel disc, the method comprising:
a maximum backward position setting of setting a reference position to a maximum backward position when the position at which the piston can move backward at the maximum is referred to as the maximum backward position;
a position controlling of continuously controlling the position of the piston by moving the piston forward or backward based on the reference position;
a braking force determining of determining whether a braking force is generated when the piston is located at the reference position during the position controlling; and
in response to a determination that the braking force is generated, a maximum backward position resetting of resetting the maximum backward position to a position other than the reference position; and
controlling the position of the piston based on the reset maximum backward position.

2. The control method of electro-mechanical brake of claim 1, wherein:
the reference position refers to:
a position of the piston immediately before a braking force starts to be generated by advancing the piston away from a brake pad toward the brake pad in a vehicle initial state that is a state before traveling of the vehicle starts.

3. The control method of electro-mechanical brake of claim 1, wherein:
the maximum backward position resetting comprises:
resetting the position of the piston, which has moved further backward from the reference position, as the maximum backward position.

4. The control method of electro-mechanical brake of claim 3, wherein:
the maximum backward position resetting comprises:
a first resetting of resetting a first position, which is a position when the piston has moved further backward by a first threshold from the reference position, to the maximum backward position;
a second resetting of resetting a second position, which is a position when the piston has moved further backward by a second threshold from the reference position, to the maximum backward position; and
a third resetting of resetting a third position, which is a position when the piston has moved further backward by a third threshold from the reference position, to the maximum backward position,
wherein the magnitudes of the first threshold to the third threshold are:
such that the third threshold is the largest and the first threshold is the smallest.

5. The control method of electro-mechanical brake of claim 1, wherein:
the braking force determining comprises:
determining that a braking force is generated when a vehicle speed reduction phenomenon occurs, the vehicle speed reduction phenomenon being a phenomenon in which a calculated vehicle speed calculated based on a signal of a wheel speed sensor is smaller than a reference vehicle speed;
wherein the reference vehicle speed refers to:
a vehicle speed when no thermal expansion of the brake pad has occurred.

6. The control method of electro-mechanical brake of claim 1, wherein:
the braking force determining comprises:
determining that a braking force is generated when a non-braking force control signal for moving the piston backward to the reference position is generated for more than a threshold time in the position controlling; and
wherein the threshold time refers to:
a time required for the piston located at the most advanced position to move backward and reach a position where no braking force is generated.

7. An electro-mechanical brake comprising a piston configured to move forward toward a wheel disc or backward to the opposite side of the wheel disc, comprising:
at least one or more processors configured to:
perform a maximum backward position setting of setting a reference position to a maximum backward position when the position at which the piston can move backward at the maximum is referred to as the maximum backward position;
perform a position controlling of continuously controlling the position of the piston by moving the piston forward or backward based on the reference position;
perform a braking force determining of determining whether a braking force is generated when the piston is located at the reference position during the position controlling;
in response to a determination that the braking force is generated, perform a maximum backward position resetting of resetting the maximum backward position as a position other than the reference position; and
control the position of the piston based on the reset maximum backward position.

8. The electro-mechanical brake of claim 7, wherein:
the reference position refers to:
a position of the piston immediately before a braking force starts to be generated by advancing the piston away from a brake pad toward the brake pad in a vehicle initial state that is a state before traveling of the vehicle starts.

9. The electro-mechanical brake of claim 7, wherein:
the maximum backward position resetting comprises:
resetting the position of the piston, which has moved further backward from the reference position, as the maximum backward position.

10. The electro-mechanical brake of claim 9, wherein:
the maximum backward position resetting comprises:
a first resetting of resetting a first position, which is a position when the piston has moved further backward by a first threshold from the reference position, to the maximum backward position, a second resetting of resetting a second position, which is a position when the piston has moved further backward by a second threshold from the reference position, to the maximum backward position; and
a third resetting of resetting a third position, which is a position when the piston has moved further backward by a third threshold from the reference position, to the maximum backward position,
wherein the magnitudes of the first threshold to the third threshold are:
such that the third threshold is the largest and the first threshold is the smallest.
